(19) United States
(12) Patent Application Publication
(10) Pub. No.: US 2022/0119608 A1
(43) Pub. Date: Apr. 21, 2022

(54) Fire-Retardant Composite Materials

(71) Applicant: Gurit (UK) Ltd., Newport (GB)

(72) Inventor: Damian Bannister, Winchester (GB)

(21) Appl. No.: 17/428,293

(22) PCT Filed: Jan. 8, 2020
(86) PCT No.: PCT/EP2020/050326

§ 371 Date: Aug. 4, 2021

(30) Foreign Application Priority Data
Mar. 8, 2019 (GB) 1903221.8

(51) Int. Cl. C08J 5/24; C08J 9/10; C08J 9/00; C08K 3/04; C08K 3/32; C08K 3/38; C08K 3/34; C09K 21/04; C08J 5/12; B32B 5/02; B32B 3/12; B32B 5/08; B32B 7/12; B32B 29/02

(52) U.S. Cl. CPC C08J 5/249; B32B 2605/003; C08J 9/108; C08J 9/0085; C08J 9/0066; C08K 3/04; C08K 3/32; C08K 3/38; C08K 3/34; C09K 21/04; C08J 5/121; B32B 5/024; B32B 3/12; B32B 5/08; B32B 7/12; B32B 29/02; C08J 2363/00; C08K 2003/387; C08K 2003/343; C08K 2003/323; B32B 2605/18; B32B 2307/3065; B32B 2605/10; B32B 2260/021; B32B 2260/046; B32B 2262/101; B32B 2262/106; B32B 2307/718; B32B 2262/148; B32B 2250/40; B32B 2250/03; B32B 2255/12; B32B 2255/26; B32B 2262/0269; B32B 2307/544; C08J 5/247

(57) ABSTRACT

A prepreg including an epoxide resin matrix system and fibrous reinforcement, at least partially impregnated by the epoxide resin matrix system, the epoxide resin matrix system having the components:
a. a mixture of (i) at least one epoxide-containing resin and (ii) at least one catalyst for curing the at least one epoxide-containing resin; and
b. a plurality of solid fillers for providing fire retardant properties to the fibre-reinforced composite material formed after catalytic curing of the at least one epoxide-containing resin, and
wherein the fibrous reinforcement is a woven fabric ply of an interwoven mixture of glass fibres and carbon fibres, the woven fabric ply has a weight of from 350 to 550 g/m² and is from 40 to 95 wt % glass fibres and from 5 to 60 wt % carbon fibres, each based on the weight of the woven fabric ply, and the proportion by weight of carbon fibres, expressed as C in wt %, in the woven fabric ply is defined by the formula:

$$C \geq ( - 0.0048 W + 2.0858 ) \times 100 \% ,$$

where W is the weight of the woven fabric ply in g/m²,
   and the proportion by weight of glass fibres, expressed as G wt %, in the woven fabric ply is defined by the formula: G=(100−C) %.

### FIELD OF THE INVENTION

The present invention relates to fire-retardant fibre-reinforced composite materials and to prepregs therefor. The present invention also relates to fire-retardant sandwich panels.

### BACKGROUND

It is well known to use fibre-reinforced resin composite materials for the manufacture of structural and decorative components in a variety of industrial sectors. For some applications, the fibre-reinforced resin composite materials are manufactured from what are known in the art as prepregs—a prepreg comprises fibrous material pre-impregnated with a resin, and the amount of resin is matched to the amount of fibre so that after plural prepregs have been laid up into a mould and the resin has cured, optionally with a preliminary full wetting out of the fibrous material by the resin if the prepreg was initially not fully impregnated, a unitary fibre-reinforced composite material moulding is formed with the correct ratio of fibre to resin so that the material has the required material properties.

When a composite material is used for interior panel construction for mass transport applications, such as aerospace, trains, ferries, etc., in particular for the interiors of such vehicles, a fire, smoke and toxicity requirement is necessary. Historically, composite materials such as phenolic, cyanate-ester, sheet moulding compound (SMC), modified vinyl-ester and halogenated epoxides have been used for these applications.

Prepregs employing a phenolic-based resin have been historically used for interior panels in aerospace and mass transit applications for many decades. Typically, the interior panels for passenger aircraft are currently made from a sandwich structure using fibre-reinforced phenolic resin skins on a honeycomb core. The core thickness typically varies from 3.2 mm to 12.7 mm (⅛″ to ½″). When the sandwich panel is made by the crushed core process under an applied pressure in a press, the skin is typically a single ply of woven glass fabric impregnated with a phenolic resin matrix system, although more than one ply of woven glass fabric impregnated with a phenolic resin matrix system may be employed. When the sandwich panel is made by a vacuum bag process, in which atmospheric pressure is applied to a vacuum bag containing the panel to be moulded, the skin is typically a stack of two plies of woven glass fabric impregnated with a phenolic resin matrix system. The honeycomb core is typically composed of aramid fiber paper coated with a phenolic resin, for example Nomex® honeycomb available in commerce from Du Pont, USA.

Although such phenolic resins offer excellent fire, smoke and toxicity (“FST”) properties, there is an industry desire to seek replacement resin materials for such prepregs which offer improved surface properties for the resultant sandwich panels, as well as improved health and safety performance, and lower-cost processing, than phenolic resins, without compromising the FST properties provided by the known phenolic resin panels.

Phenolic resins for use in such prepregs are cured using a condensation reaction which releases volatiles and water during curing. This requires the use of press-curing under an imposed pressure, or an autoclave, in order to impart high pressures (6 bar) to reduce the expansion of large voids within the laminate during curing of the resin. Such voids would otherwise decrease the mechanical properties of the laminate. Secondly, the release of volatiles creates poor surface finishes that require significant filling and fairing of the cured components at a substantial additional cost. The release of volatile components, and solvents, also results in the need to take specific health and safety precautions when using such phenolic resins. Therefore, in addition to the additional cost of filling and fairing, the phenolic matrix in currently available phenolic resin prepregs also has a poor health and safety rating due to free formaldehyde and residual phenol.

Many phenolic resin aerospace component manufacturers have problems with the final surface quality of the phenolic resin component when removing from the mould and have to spend time filling and fairing to enable the required surface quality for painting or applying protective films, for example composed of polyvinyl fluoride, for example Tedlar® polyvinyl fluoride films available in commerce from Du Pont, USA.

A first primary surface quality defect of phenolic resin sandwich panels is the presence of porosity in the cured phenolic resin layer, particularly at a surface intended to be a cosmetic “A” surface which is mounted or intended to be viewed in use, for example an interior surface of an aircraft wall lining panel. The porosity is generally related to the void content in the cured phenolic resin layer, and a good surface finish is generally associated with low void content.

A second primary surface quality defect is known as “telegraphing”. Phenolic resin prepregs are used to form outer surface layers of sandwich panels incorporating a central core layer. Telegraphing is exhibited in a sandwich panel incorporating a cured phenolic resin layer moulded onto a core layer comprising a non-metallic honeycomb material, for example a honeycomb material composed of aramid fiber paper coated with a phenolic resin, for example Nomex® honeycomb available in commerce from Du Pont, USA. Telegraphing is a defect caused by the surface ply of the cured phenolic resin layer being slightly depressed into each cell of the honeycomb creating a dimpled texture, similar in visual appearance to the texture of a golf ball. This kind of defect is more prevalent when the component is manufactured under vacuum bag curing conditions, where the moulding pressure is provided by applying a vacuum and therefore by atmospheric pressure alone, than under press-moulding which does not, in most press-moulding applications, use a vacuum.

These types of sandwich panels for interior panel constructions for transport applications, such as for aerospace interiors, are typically made by three common processes. In one known process, which is typically used for components having a complex shape, the sandwich components are laid up in an open mould and then subjected to a vacuum bag moulding process with the resin being cured in an oven or an autoclave. In a second known process, the sandwich components are compression moulded in a press; the process is known in the art as the “crushed core” process because some parts of the panel are crushed to a lower thickness than other parts. In a third known process, the sandwich components are compression moulded to form flat panels in a Multiple Opening Press (MOP) process.

As aircraft production numbers increase, it is also desirable that the resin matrix in the prepreg cures quickly to enable faster production cycle times to manufacture sandwich panels. In addition, there is a desire to reduce tooling costs and to increase production capacity on the more expensive capital equipment items, for example presses, autoclaves and ovens.

The mechanical properties of the phenolic resins are generally much lower than that of an epoxy resin but in general the mechanical requirements for aircraft interior components are low. However, it should be expected that in the future that may be an increased requirement for aircraft interior panels to have increased mechanical properties as compared to current panels. Therefore it would be desirable to produce a sandwich panel in which the surface composite material layers have increased mechanical properties as compared to current known phenolic resin sandwich panels.

Catalytically-cured epoxide resins are well known in the composites industry to offer excellent mechanical properties and good health and safety properties. They are however, intrinsically flammable materials and, when used unmodified, are not suitable for applications where fire, smoke and toxicity properties are required. This has mitigated against their use in the aerospace industry, particularly for interior components. Epoxides have commonly been modified with halogens (such as bromine and chlorine) in order to impart fire-retardant properties to the cured matrix. The two main disadvantages to this approach are high toxicity of smoke emissions, which emissions are typically at a high level, during combustion and poor health and safety characteristics associated with the material in both the uncured and cured state.

Therefore despite the problems with phenolic resins as described above, and in light of the disadvantages of epoxy resins as also described above, phenolic resins have been very hard to displace from these aerospace applications, particularly for interior components, due to their excellent smoke, flame resistance and heat release properties. Furthermore, phenolic resins have a low cost compared to other chemicals that have the required FST properties.

The present inventors have addressed these problems of known composite materials and have aimed to provide fire-retardant fibre-reinforced composite materials, and prepregs therefor, which can exhibit good fire-retardant properties in combination with good surface properties and aesthetic properties, as well as low weight coupled with good mechanical properties, and in conjunction with good processability, with regard to cost and health and safety considerations.

### SUMMARY OF THE INVENTION

The present invention aims to provide a composite material, including a prepreg for producing the composite material and a sandwich panel made from the composite material, which can provide the combination of the following properties: low areal weight coupled with high mechanical properties, in particular long beam flexural strength and long beam flexural stiffness; the heat release, smoke and flammability properties of the composite material on combustion should be close to those of current commercial phenolic resins; an improved surface finish as compared to current commercial phenolic resins should be achieved to reduce/eliminate fill and fairing; a fast curing resin system should be present; a similar price to that of current commercial phenolic resin prepregs should be available; and good mechanical performance properties for adhesion to a core material, such as a honeycomb core material, should be provided.

Also, the composite material, a prepreg for producing the composite material and sandwich panel made from the composite material should provide improved health and safety characteristics as compared to the current use of uncured and cured phenolic resins.

Furthermore, the prepreg and core pre-assembly should be able to avoid or minimise telegraphing in the final sandwich panel yet provide a high bond, and high peel strength, between the surface layer of fibre-reinforced resin matrix material, which is formed from the prepreg, and the honeycomb core, particularly if a low pressure vacuum bag moulding process is employed to manufacture the sandwich panel.

Accordingly, in a first aspect, the present invention provides a prepreg.

In a second aspect, the present invention provides a fire-retardant sandwich panel for use as an interior component in a vehicle, the sandwich panel comprising a core layer and an outer surface layer bonded to a surface of the core layer, wherein the outer surface layer comprises a fibre-reinforced composite material formed from at least one layer of a prepreg according to the present invention.

In a third aspect, the present invention provides a fire-retardant sandwich panel for use as an interior component in a vehicle.

In a fourth aspect, the present invention provides a method of making a fire-retardant sandwich panel according to the second or third aspects.

The fire-retardant sandwich panel is preferably moulded to comprise an interior panel of an aircraft or a railway vehicle.

The preferred embodiments of the present invention can provide an epoxy resin prepreg that can be used to produce a high strength low weight sandwich panel that also meets the primary requirement of the heat release and FST requirements which has been the major hurdle to be overcome by epoxy resin products for these aerospace applications in order to be competitive to, or exceed the performance of, current commercial phenolic resins. The prepreg can also produce a high quality cosmetic surface, for example for use as an “A” surface of a panel, which is in use mounted or intended to be seen, for example as an interior surface of an aircraft cabin.

An advantage of an epoxide resin as a monomer molecule for producing a cured thermoset resin is that the epoxide resin is cured in a catalytic addition reaction rather than a condensation reaction and so, unlike phenolic resins, the epoxide resin does not evolve any by-product during the curing reaction. Therefore when the epoxy resin used in the preferred embodiments of the present invention is cured no volatiles are evolved that might cause surface porosity.

Epoxy resins also exhibit excellent adhesive properties and mechanical properties. Therefore the epoxy resins used in the preferred embodiments of the present invention can easily meet the adhesive bonding requirements to enable the epoxy resin surface layers to bond strongly to the surface of a honeycomb core material, for example composed on Nomex® honeycomb.

The chemistry of epoxy resins also enables fast cure times over a selectable range of curing temperatures, depending upon the selection of the catalyst, and optionally the accelerator, making epoxy resins used in the preferred embodiments of the present invention suitable for the three main moulded panel production processes of vacuum bag processing, crushed core processing, and multiple opening press (MOP) processing as described above.

The prepregs comprise epoxy resin in combination with the fibrous reinforcement, in the form of a woven fabric comprising both glass fibres and carbon fibres, i.e. a “hybrid” glass/carbon woven fabric. The use of this specific fabric can provide the advantage of high long beam flexural stiffness and strength in a sandwich panel having low weight.

The addition of carbon fibres to a woven fabric of glass fibres adds significant stiffness to the resultant layer of fibre-reinforced resin matrix composite material. Accordingly, the weight of the prepreg ply to produce such a layer of a given stiffness can be reduced, by reducing the fabric weight and also by reducing the weight of the epoxy resin in the prepreg ply.

During combustion of the fibre-reinforced resin matrix composite material, the carbon releases (per unit weight) more heat of combustion than glass, and therefore the amount of carbon in the panel, and correspondingly in the “hybrid” glass/carbon woven fabric, needs to be kept to a minimum. It is also desirable to keep the amount of carbon in the panel, and correspondingly in the “hybrid” glass/carbon woven fabric, to a minimum in order to reduce material costs. However, the additional cost of carbon fibres as compared to glass fibres is offset by the panel only requiring on each outer surface a single ply of the “hybrid” glass/carbon woven fabric, as compared to multiple plies of glass woven fabric, which therefore saves prepreg conversion costs, consumables and process time when manufacturing the panel.

The present inventors have, based on their research, unexpectedly found a specific woven fabric to use in an epoxide resin sandwich panel which can provide the combination of low weight and high mechanical properties, particularly flexural properties, and also good FST and surface properties, as well as fast curing associated with epoxide resins.

The FST properties of epoxy resins used in the preferred embodiments of the present invention have been achieved by adding various solid fire retardant components to the epoxy formulation, in particular solid fillers, typically in particulate form, and as a result the liquid content of the prepreg, the liquid being present during curing of the prepreg at an elevated curing temperature, is relatively low as compared to epoxy prepregs which do not exhibit FST properties.

The present invention preferably provides an epoxy resin system that can provide a liquid content, which is above a minimum threshold, during curing to provide good mechanical adhesion of the resultant cured composite material to the honeycomb core, while still achieving a high FST performance of the resultant cured composite material. In addition, the liquid content preferably provides liquid during curing to create a coherent continuous layer at the tool-to-prepreg interface, which can ensure achieve low surface porosity of the cured sandwich panel.

In particular, the present invention preferably provides during curing a minimum liquid resin content that provides a combination of both (i) good adhesion strength to the honeycomb core and (ii) a good surface finish in the sandwich panel.

In one preferred aspect of the present invention, it has been found that the liquid resin content minimum threshold is 140 g/m² to produce a good surface finish, at least one side of a panel to enable that side to be used as a cosmetic “A” surface, for example as an interior cosmetic “A” surface of an aircraft cabin. The liquid resin content is the content of liquid resin during curing.

For example, it has been found that with a 300 g/m² (grams per square metre) fabric, which is a standard fabric weight for aircraft interior sandwich panels, the liquid resin content minimum threshold is 140 g/m² to produce a good surface finish, for example in the crush core process. For heavier fabrics, as a general rule the liquid resin content required to produce a good surface finish generally increases from this minimum threshold.

The preferred embodiments of the present invention preferably provide an epoxy resin system that also retains good mechanical performance in a sandwich panel despite having a high filler content, and in particular it has been found that the a high filler content in the epoxy resin system of an outer surface layer of fibre-reinforced epoxy resin matrix composite material can increase the long beam flexural strength of a sandwich panel.

### BRIEF DESCRIPTION OF THE DRAWINGS

Preferred embodiments of the present invention will now be described by way of example only with reference to the accompanying drawings, in which:

FIG. 1 is a schematic side view of a sandwich panel pre-assembly incorporating a prepreg and a core in accordance with an embodiment of the present invention;

FIG. 2 is a schematic perspective view of a sandwich panel in accordance with an embodiment of the present invention produced from the pre-assembly of claim 1;

FIG. 3 is a schematic cross-section through a prepreg in accordance with an embodiment of the present invention used in the pre-assembly of FIG. 1 for manufacture of the sandwich panel of FIG. 2; and

FIG. 4 is a graph showing the relationship between calculated values of long beam flexural strength with respect to carbon fibre content in wt % (y axis) and fabric weight in g/m² (x axis) for sandwich panels in accordance with embodiments of the present invention.

### DETAILED DESCRIPTION

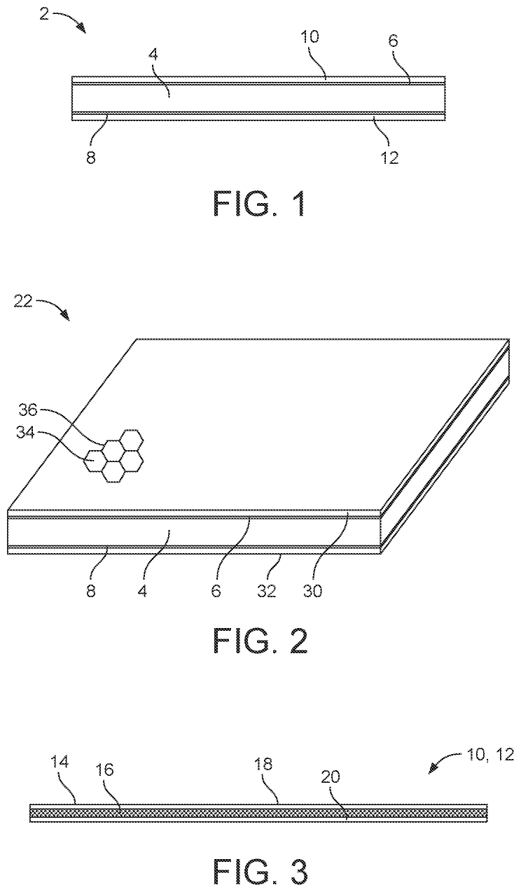

Referring to FIG. 1, there is shown a sandwich panel pre-assembly incorporating a prepreg and a core in accordance with an embodiment of the present invention prepreg. The prepreg is formulated for the manufacture of a fibre-reinforced composite material having fire retardant properties. The prepreg is shown in FIG. 3. The sandwich panel pre-assembly is used to produce a sandwich panel as shown in FIG. 2. FIGS. 1, 2 and 3 are not to scale and some dimensions are exaggerated for the sake of clarity of illustration.

As shown in FIG. 1, the sandwich panel pre-assembly 2 comprises a central core layer 4 having opposite surfaces 6, 8. A prepreg layer 10, 12 is disposed on each respective surface 6, 8 of the core layer 4.

The sandwich panel pre-assembly 2 is used to produce a fire retardant sandwich panel 22 as shown in FIG. 2. The sandwich panel pre-assembly 22 comprises the central core layer 4 having opposite surfaces 6, 8. An outer surface layer 30, 32 of fibre-reinforced resin matrix composite material, each formed from a respective prepreg layer 10, 12 as shown in FIG. 1, is bonded to a respective surface 6, 8 of the core layer 4. Typically, the fire-retardant sandwich panel 22 is moulded to comprise an interior panel of a vehicle, optionally an aircraft or a railway vehicle. The bonding together of the outer surface layers 30, 32 of fibre-reinforced resin matrix composite material to the core layer 4 is achieved during the moulding process for forming the sandwich panel 22 and the epoxy resin system in the prepreg layers 10, 12 of the pre-assembly 2 of FIG. 1 bonds directly to the surfaces 6, 8 of the core layer 4.

In the sandwich panel 22 of the illustrated embodiment, two opposite outer surface layers 30, 32 of fibre-reinforced resin matrix composite material, are provided, each outer surface layer 30, 32 being bonded to a respective opposite surface 6, 8 of the core layer 4.

However, the present invention can alternatively produce a sandwich panel having a two layer structure comprising a core layer and a single layer of fibre-reinforced composite material on one surface of the core layer, which is formed by providing a prepreg layer on one side of the core layer in the sandwich panel pre-assembly.

The core layer 4 is composed of a structural core material comprising a non-metallic honeycomb material. Typically, the honeycomb material is composed of aramid fiber paper coated with a phenolic resin, for example Nomex® honeycomb available in commerce from Du Pont, USA. The honeycomb material comprises an array of elongate cells 34 which extend through the thickness of the core layer 4 so that, as shown in FIG. 2, each opposite surface 6, 8 of the core layer 4 is an end surface of the honeycomb material including a matrix surface 36 surrounding a plurality of cells 34. The matrix surface 36 and cells 34 are shown notionally uncovered in FIG. 2 for the sake of clarity of illustration, but they are covered by the outer layers 30, 32 of fibre-reinforced resin matrix composite material, although if the outer surface layers 30, 32 are translucent then the matrix surface 36 and cells 34 can be seen through the outer layers 30, 32. The core layer 4 typically has a thickness of from 3 to 25 mm, although other core thicknesses may be employed.

In alternative embodiments, the core layer 4 may be composed of a structural foam, for example a polyethersulphone (PES) foam (e.g. sold by Diab under the trade name Divinycell®).

In alternative embodiments, the core layer 4 may be a honeycomb core material composed of aluminium or an aluminium alloy.

As shown in FIG. 3, the prepreg of the prepreg layers 10, 12 comprises an epoxide resin matrix system 14 and fibrous reinforcement 16 which is at least partially impregnated by the epoxide resin matrix system 14. For each of the prepreg layers 10, 12, a ply of the fibrous reinforcement 16 is sandwiched between a pair of outer resin layers 18, 20 of the epoxide resin matrix system 14. Preferably, the prepreg is halogen-free and/or phenolic resin-free. Typically, the fibrous reinforcement 16 is fully impregnated by the epoxide resin matrix system 14 by the opposite resin layers 18, 20 to provide resin surfaces on opposite sides of the prepreg layer 10, 12. Alternatively, the fibrous reinforcement 16 may be fully impregnated by the epoxide resin matrix system 14 to produce the prepreg of the prepreg layers 10, 12 as a result of immersion of the fibrous reinforcement 16 in a bath of the epoxide resin matrix system 14, optionally admixed with a solvent, and optional pressure to remove excess liquid resin, for example using nip rollers.

In accordance with the present invention, the fibrous reinforcement 16 comprises a woven fabric ply comprising an interwoven mixture of glass fibres and carbon fibres. This specific woven fabric ply is also referred to as a “hybrid glass/carbon” woven fabric in the present specification. The woven fabric ply has a weight of from 350 to 550 g/m² and comprises from 40 to 95 wt % glass fibres and from 5 to 60 wt % carbon fibres, each based on the weight of the woven fabric ply.

In preferred embodiments of the present invention, the woven fabric ply has a weight of from 350 to 500 g/m² and comprises from 50 to 95 wt % glass fibres and from 5 to 50 wt % carbon fibres, each based on the weight of the woven fabric ply. In other preferred embodiments of the present invention, the woven fabric ply has a weight of from 350 to 450 g/m² and comprises from 60 to 95 wt % glass fibres and from 5 to 40 wt % carbon fibres, each based on the weight of the woven fabric ply.

In addition, according to the present invention there is a particular relationship between the proportion of carbon fibres in the hybrid glass/carbon woven fabric and the fabric weight of the hybrid glass/carbon woven fabric which has been found to provide a high level of mechanical properties in a sandwich panel incorporating an outer surface layer bonded to a core, wherein the outer surface layer comprises a fibre-reinforced composite material formed from the prepreg comprising the hybrid glass/carbon woven fabric.

This relationship is defined as follows: the proportion by weight of carbon fibres, expressed as C in wt %, in the woven fabric ply is defined by the formula:

$$C \geq ( - 0.0048 W + 2.0858 ) \times 100 \% ,$$

where W is the weight of the woven fabric ply in g/m²,
and the proportion by weight of glass fibres, expressed as G wt %, in the woven fabric ply is defined by the formula: G=(100−C) %.

Preferably, the proportion by weight of carbon fibres, expressed as C in wt %, in the woven fabric ply is defined by the formula:

$$C \geq ( - 0.0045 W + 2.075 ) \times 100 \% ,$$

where W is the weight of the woven fabric ply in g/m²,
   and the proportion by weight of glass fibres, expressed as G wt %, in the woven fabric ply is defined by the formula: G=(100−C) %.

This relationship has been determined by the present inventors as a result of carrying out experimental and calculated analysis of the mechanical behaviour of such a sandwich panel. It has unexpectedly been found by the present inventors that by providing such a relationship between the proportions of carbon and glass fibres in the woven fabric ply and the weight of the woven fabric ply, together with the ranges of the absolute weight of the woven fabric ply and the absolute proportions of the carbon and glass fibres in the woven fabric ply, the resultant sandwich panel can exhibit a high long beam flexural strength and a high long beam flexural stiffness in a lightweight panel construction.

In this specification, each reference to “flexural strength” refers to “long beam flexural strength” and each reference to “flexural stiffness” refers to “long beam flexural stiffness”.

In particular, it has been found that by providing such a relationship between the proportions of carbon and glass fibres in the woven fabric ply and the weight of the fabric ply, together with the ranges of the absolute weight of the woven fabric ply and the absolute proportions of the carbon and glass fibres in the woven fabric ply, the resultant sandwich panel can exhibit a long beam flexural strength of at least 25 Ksi (Kilopounds per square inch), equivalent to 17.24 kilonewton/centimeter², preferably at least 27 Ksi (equivalent to 18.62 kilonewton/centimeter²), and a long beam flexural stiffness of at least 110 lbs/in (equivalent to 19264 N/m). This long beam flexural strength of 27 Ksi (equivalent to 18.62 kilonewton/centimeter²) is a minimum standard that is set by a well-known aircraft manufacturer, although the lower minimum threshold of 25 Ksi (equivalent to 17.24 kilonewton/centimeter²) is nevertheless acceptable for many aerospace applications. Accordingly, a lower boundary for the sandwich panel long beam flexural strength may be considered to be 25 Ksi (equivalent to 17.24 kilonewton/centimeter²) and an upper boundary for the sandwich panel long beam flexural strength may be considered to be 29 Ksi (equivalent to 20.00 kilonewton/centimeter²), because there is no technical or commercial advantage to provide an even higher long beam flexural strength sandwich panel for interior use in aerospace.

These parameters of the proportions of carbon and glass fibres in the woven fabric ply and the weight of the woven fabric ply in accordance with the present invention have been found to enable the minimum flexural properties typically required by an interior sandwich panel used in the aerospace industry to be met or exceeded. At lower fabric weights than required by the present invention, the sandwich panel would exhibit low long beam flexural strength and would not pass a bending strength test of the aerospace industry. At higher carbon fibre contents than required by the present invention, the sandwich panel would exhibit lower fire retardancy performance and may not pass an FST test of the aerospace industry, and also the cost of the high carbon fibre content sandwich panel would not be commercially acceptable for use as an interior panel in the aerospace industry. Correspondingly, at lower carbon fibre contents than required by the present invention, the sandwich panel would exhibit low long beam flexural strength and would not pass a bending strength test of the aerospace industry, and furthermore the sandwich panel would exhibit low long beam flexural modulus, i.e. stiffness, for lower areal weight fabrics and would not pass a long beam flexural modulus test of the aerospace industry. At higher fabric weights than required by the present invention, the sandwich panel would exhibit excessive weight and would not exhibit any improvement in weight saving, long beam flexural strength or FST performance as compared to conventional glass fibre sandwich panels for use as an interior panel in the aerospace industry.

In summary, the present invention can provide a sandwich panel, and a prepreg therefor, which is lightweight yet has high long beam flexural strength and good FST properties, and can provide lighter sandwich panels, as compared to conventional glass fibre sandwich panels, for use as an interior panel in the aerospace industry without compromising on mechanical or FST performance and without any significant increase in manufacturing cost, as compared to conventional glass fibre sandwich panels.

The lightweight panel construction typically comprises only a single woven fabric ply in each outer surface layer bonded to the central core. Furthermore, the outer surface layer contains fire retardant fillers to provide FST properties to the sandwich panel, for example to enable the panel to be used as an interior panel of an aircraft, yet can provide a strong bond between the outer surface layer and the central core as a result of the liquid content of the resin contacting the surface of the core during the curing cycle.

Preferably, the woven fabric ply comprises an interwoven mixture of glass fibre tows and carbon fibre tows, each tow comprising a plurality of filaments of glass fibre or carbon fibre respectively, each interwoven carbon fibre tow comprises from 2000 to 7000 carbon fibre filaments, preferably from 3000 to 6000 carbon fibre filaments, for example about 3000 carbon fibre filaments. At relatively high carbon fibre filament number in the carbon fibre tow, for example up to 12000 carbon fibre filaments, the tow cost is decreased and may be acceptable for some parts, but it is more difficult using high carbon filament number tows to make an interwoven hybrid carbon:glass fibre fabric having the desired surface finish and drape properties for the manufacture of high quality surface parts such as interior panels for aircraft.

In preferred embodiments of the present invention, the woven fabric ply comprises a satin weave which is an n-harness satin weave in which n is an integer of at least 4 for example from 4 to 8 or from 5 to 8, typically 5. Typically, in the satin weave the carbon fibres form at least a portion of both the warp fibres and the weft fibres and the glass fibres form at least a portion of the weft fibres.

By providing a satin weave with an n-harness pattern as described above, this readily allows a hybrid carbon/glass fibre fabric to be manufactured with the desired weight ratio between the carbon fibres and the glass fibres. Also, the satin weave provides good drape properties for forming three-dimensionally shaped parts, a closed structure to the fabric, and good surface finish in the sandwich panel.

However, in some embodiments in which the prepreg is not required to drape during the moulding process, for example when making a planar composite material part, other weave configurations may be used, for example a plain weave, or a twill weave, the twill weave having an n×n weave pattern, for example where n is from 2 to 5. In such fabrics comprising an interwoven mixture of glass fibre tows and carbon fibre tows, each interwoven carbon fibre tow may comprises from 2000 to 12000 carbon fibre filaments, preferably from 2000 to 7000 carbon fibre filaments, more preferably from 3000 to 6000 carbon fibre filaments, for example about 3000 carbon fibre filaments.

In preferred embodiments of the present invention, the single prepreg of each of the prepreg layers 10, 12 has a total weight of from 550 to 800 g/m², typically from 550 to 700 g/m². For example, when the woven fabric ply has a weight of 350 g/m² and the prepreg comprises 38 wt % of a filled epoxide resin matrix system and 62 wt % of the woven fabric ply, the prepreg weight may typically be about 565 g/m² or when the woven fabric ply has a weight of 425 g/m² and the prepreg comprises 38 wt % of a filled epoxide resin matrix system and 62 wt % of the woven fabric ply, the prepreg weight may typically be about 685 g/m².

The epoxide resin matrix system comprises the components:
a. a mixture of (i) at least one epoxide-containing resin and (ii) at least one catalyst for curing the at least one epoxide-containing resin; and
b. a plurality of solid fillers for providing fire retardant properties to the fibre-reinforced composite material formed after catalytic curing of the at least one epoxide-containing resin.

In preferred embodiments of the present invention, in component (a) the at least one epoxide-containing resin comprises a mixture of at least two epoxide-containing resins and has a liquid/solid weight ratio of from 1.3:1 to 1.475:1, typically from 1.35:1 to 1.45:1, for example from 1.38:1 to 1.39:1, the liquid and solid constituents being liquid or solid at room temperature (20° C.). In component (b), the at least one catalyst may be a liquid catalyst, or alternatively the at least one catalyst may comprise from 40 to 60 wt % solid and from 60 to 40 wt % liquid, each wt % being based on the weight of the catalyst and determined at room temperature (20° C.).

In preferred embodiments of the present invention, the at least one epoxide-containing resin, and optionally the at least one catalyst, comprise a liquid-forming component of the prepreg, which liquid-forming component is adapted to liquefy during at a curing temperature during curing of the at least one epoxide-containing resin by the at least one catalyst, and wherein the liquid-forming component of the prepreg has a weight of from 140 to 205 g/m². Typically, the liquid-forming component of the prepreg has a weight of from 150 to 180 g/m², typically from 155 to 170 g/m².

The epoxide-containing resin may further comprise a catalyst carrier which acts to assist incorporation of the latent catalyst for the epoxide resin into the composition. Typically, the catalyst carrier comprises a diglycidyl ether of bisphenol F liquid resin. For example, the catalyst carrier may comprise a diglycidyl ether of bisphenol F liquid resin available in commerce under the trade name Epikote 862 from Hexion. The catalyst carrier may typically be present in the resin composition in an amount of up to 10 wt %, based on the total weight of the epoxide-containing resin.

The catalyst of component (a)(ii) comprises a catalyst, otherwise called a curing agent, suitable for curing epoxide resins, optionally together with at least one additional catalyst additive or modifier. Any suitable catalyst may be used. The catalyst will be selected to correspond to the resin used. The catalyst may be accelerated. The catalyst or curing agent may typically be selected from a dicyandiamide, sulphanilamide, urone, urea, imidazole, amine, halogenated boron complex, anhydride, lewis base, phenolic novolac, or a nitrogen containing compound. Latent curing agents such as dicyandiamide, fenurone and imidazole may be cured. Suitable accelerators include Diuron, Monuron, Fenuron, Chlortoluron, his-urea of toluenedlisocyanate and other substituted homologues. Typically, the curing catalyst for the epoxide-containing resin is dicyandiamide, most preferably being in micronized form, and such a catalyst is available in commerce under the trade name Dyhard® 100SF from AlzChem Group AG. The curing catalyst may typically be present in the resin composition in an amount of from 1 to 15 wt %, more typically from 2 to 6 wt %, based on the total weight of the epoxide-containing resin. Too low an amount of the curing catalyst may cause a reduced cure of the resin material, whereas too high an amount may cause an excessively exothermic cure.

The curing catalyst may be combined with an additional catalyst additive to reduce the activation energy, and hence the curing temperature, of the primary curing catalyst such as dicyandiamide. Such an additive may comprise urone, available in commerce under the trade names Amicure® UR-S or Amicure® UR-2T from Evonik. Such an additive may typically be present in the resin composition in an amount of up to 15 wt %, more typically from 1 to 4 wt %, based on the total weight of the epoxide-containing resin.

The curing catalyst may be yet further be combined with an additional additive imidazole-based catalyst or curing agent provided to further reduce the activation energy, and hence the curing temperature, of the urone. In addition, the C═N bonds present in imidazole have been shown to improve the fire-retardant properties of the resultant cured epoxide-resin compared to other catalysts. Such an imidazole-based catalyst or curing agent is available in commerce under the trade name 2MZ-Azine-S from Shikoku, Japan. The imidazole-based catalyst or curing agent may typically be present in the resin composition in an amount of up to 15 wt %, more typically from 1 to 4 wt %, based on the total weight of the epoxide-containing resin. A low amount of the imidazole-based catalyst or curing agent may cause a reduced cure speed and/or reduced curing temperature of the resin material, whereas too high an amount may cause an excessively exothermic cure.

The component (b) comprises a plurality of solid fillers for providing fire retardant properties to the fibre-reinforced composite material formed after catalytic curing of the at least one epoxide-containing resin. The solid fillers promote fire-retardancy and/or reduce generation of smoke, opacity of smoke or toxicity of smoke. Such fillers may be selected from, for example, at least one of a metal borate or silicate, e.g. zinc borate, melamine cyanurate, red or yellow phosphorus, aluminium trihydroxide (alumina trihydrate), and/or ammonium polyphosphate, or another metal or ammonium monophosphate or polyphosphate. The solid fillers may include glass beads or silica beads which are non-flammable. The solid fillers may include intercalcated graphite to function as an intumescent material. The solid fillers are typically dispersed homogeneously throughout the epoxide resin matrix.

Some known fire retardants are, for example, the fire retardants supplied by Albermarl Corporation under the trade mark Martinal®, and under the product names OL-111/LE, OL-107/LE and OL-104/LE, and the fire retardant supplied by Borax Europe Limited under the trade mark Firebrake® ZB. The fire retardant mineral filler is typically ammonium polyphosphate, for example available under the trade name Exolit AP 422 from Clariant, Leeds, UK. The smoke suppressant mineral filler is typically zinc borate, available in commerce under the trade name Firebrake® ZB. The mineral fillers may optionally be provided together with a filler dispersion additive to aid wetting and dispersion of fillers during manufacture of the matrix resin. Such a filler dispersion additive is available in commerce under the trade name BYK W980 from BYK Chemie, Wesel, Germany.

Typically, the solid fillers for providing fire retardant properties comprise three components. Component (i) comprises a phosphate component and component (ii) comprises (a) a ceramic or glass material precursor for reacting with the phosphate component to form a ceramic or glass material and/or (b) a ceramic or glass material and/or (c) and intumescent material comprising intercalcated graphite. The solid fillers are present in the form of solid filler particles. The phosphate component may comprise a metal monophosphate or polyphosphate, optionally aluminium polyphosphate, and/or ammonium monophosphate or polyphosphate. The ceramic or glass material precursor may comprise a metal borate, optionally zinc borate or a metal silicate, for example sodium silicate. The ceramic or glass material may comprise glass beads.

The prepreg may further comprise, in component (b), a third component (iii) which is a blowing agent as a fire retardant for generating a non-combustible gas when the prepreg is exposed to a fire, and the fire retardant solid fillers and blowing agent are adapted to form an intumescent char when the epoxide resin is exposed to a fire. The blowing agent is part of the solid fillers in the epoxide resin matrix system. A suitable blowing agent is melamine, which is present in the form of solid filler particles.

When the intumescent material comprises intercalcated graphite, which expands when subjected to heat, typically the intumescent material further comprises a component which releases gas when subjected to heat, for example ammonium polyphosphate and/or a blowing agent such as melamine which decomposes to release nitrogen. The released gas further expands the intercalcated graphite.

Other solid filler materials may be provided in component (b) to provide the required fire, smoke and toxicity (FST) properties to the resultant fibre-reinforced resin matrix composite material formed from the prepreg after curing of the epoxide resin matrix system.

In preferred embodiments of the present invention, the epoxide resin matrix system further comprises, in component (b), at least one anti-settling agent for the solid fillers. The anti-settling agent is typically a solid particulate material. The at least one anti-settling agent may comprise silicon dioxide, optionally amorphous silicon dioxide, further optionally fumed silica. The at least one anti-settling agent may be present in an amount of from 0.5 to 1.5 wt % based on the weight of component (a). In particular, an anti-settling additive may be provided to control resin flow during resin curing, for example during curing to adhere the resin matrix to a core. In addition, such an additive can prevent settling of powder particles, such as the fire-retardant and/or smoke suppressant fillers, in the resin formulation during storage/processing. A typical anti-settling additive comprises amorphous silicon dioxide, most typically fumed silica, for example available under the trade name Cabot Cabosil TS-720.

In accordance with the preferred embodiments of the present invention, the prepreg comprises from 35 to 50 wt % of the epoxide resin matrix system and from 50 to 65 wt % of the fibrous reinforcement, each wt % being based on the total weight of the prepreg. Optionally, the prepreg comprises from 35 to 45 wt % of the epoxide resin matrix system and from 55 to 65 wt % of the fibrous reinforcement, each wt % being based on the total weight of the prepreg. Further, optionally, the prepreg comprises from 38 to 42 wt % of the epoxide resin matrix system and from 58 to 62 wt % of the fibrous reinforcement, each wt % being based on the total weight of the prepreg.

In addition, in preferred embodiments of the present invention, the weight ratio of component (a), i.e. the epoxide-containing resin and catalyst system, to component (b), i.e. the solid fillers for providing fire retardant properties, is from 1.4:1 to 1.86:1, preferably from 1.5:1 to 1.86:1, more preferably from 1.6:1 to 1.7:1, typically from 1.625:1 to 1.675:1, for example about 1.65:1.

In a vacuum bag moulding process, the moulding pressure, which is applied by the atmosphere, is typically from 0.7 to 0.9 bar and so rather low. The low pressure is used to avoid or reduce the effects of telegraphing, i.e. witnessing in the outer surface of the moulded panel a visible honeycomb pattern as a result of the prepreg being drawn of the into the cells of the honeycomb core by the applied vacuum pressure. Also, the cure schedule typically uses a slow ramp rate, for raising the temperature to the curing temperature, for example from 1 to 3° C./minute, and the dwell temperature is typically 75° C. to maintain a high viscosity of the epoxide resin to provide a good void-free surface finish.

Under these moulding conditions, with the typical cure cycle and vacuum pressure, it can be difficult to achieve a strong bond between the adjacent surfaces of the prepreg and the honeycomb core.

However, by providing the preferred solid fillers concentration in the prepreg of the present invention, the prepreg composition has a resin content adjacent to the core which can provide a sufficient liquid resin content adjacent to the core during curing to ensure reliable bonding of the resultant composite material outer surface layer to the core, with a low void content in the composite material and a high peel strength between the composite material outer surface layer and the core. The prepreg of the preferred embodiments of the present invention can therefore provide and improved prepreg which provides enhanced performance during the vacuum bag moulding process.

In preferred embodiments of the present invention, the weight ratio of the total weight of the prepreg to the weight of component (b) is from 4.5:1 to 6.5:1, optionally from 5:1 to 6:1.

In the method of making a fire-retardant sandwich panel according to the present invention, the core layer 4 is provided. One prepreg layer 10 or each of two prepreg layers 10, 12 as described above is disposed onto a surface 6, 8 of the core layer 4 to form the sandwich panel pre-assembly 2.

The resultant sandwich panel is for use as an interior panel in a vehicle such as an aircraft and is required to have a minimum threshold of mechanical properties and structural strength, and in accordance with the present invention a single ply of the prepreg layer 10, 12 is disposed over a respective surface 6, 8 of the core layer 4.

As described above, the preferred embodiments of the present invention may use any suitable moulding process for forming the panel, for example any of the three known processes of vacuum bag processing, crushed core processing, and MOP processing as described above.

For example, the sandwich panel pre-assembly 2 is disposed on a lower mould and then subjected to vacuum bagging over the sandwich panel pre-assembly 2 in a process well known to those skilled in the art. The laid-up mould is placed in an oven or autoclave and the sandwich panel pre-assembly is heated to a curing temperature of the at least one epoxide-containing resin by the at least one catalyst.

During the heating step, the at least one epoxide-containing resin, and optionally the at least one catalyst, in the prepreg of the layer(s) 10, 12 liquefy to form a liquid-forming component which wets the surface(s) 10, 12 of the core layer 4. Preferably, the liquid-forming component which wets the surface of the core layer 4 has a weight of from 140 to 205 g/m². Typically, the liquid-forming component has a weight of from 150 to 180 g/m², typically from 155 to 170 g/m².

The heating step cures the at least one epoxide-containing resin to form the layer(s) of fibre-reinforced composite material 30, 32 bonded to the core layer 4.

Typically, during the heating step, the prepreg layer(s) 10, 12 and core layer 4 are compressed together (for example by vacuum bag processing, crushed core processing, and MOP processing). The prepreg layer(s) 10, 12 and the core layer 4 may be pressed together for a period of from 5 to 20 minutes at a temperature of from 125 to 185° C., the temperature being at least the curing temperature of the epoxy resin system including the catalyst. The prepreg layer(s) 10, 12 and core layer 4 may be pressed together to form a moulded sandwich panel 22 having a three dimension moulded shape.

In vacuum bag processing, the lower mould forms a moulded surface of the sandwich panel. The lower mould may form a sufficiently high quality surface finish, with low porosity and void content, to enable that moulded surface to be used as a high quality cosmetic “A” surface, for example as an interior cosmetic “A” surface of an aircraft cabin.

In crushed core and MOP processing, the upper and lower moulds each form a moulded surface of the sandwich panel. Typically, each of the upper and lower moulds may form a sufficiently high quality surface finish, with low porosity and void content, to enable that moulded surface to be used as a high quality cosmetic “A” surface, for example as an interior cosmetic “A” surface of an aircraft cabin.

The preferred embodiments of the present invention provide an epoxy resin prepreg that has very good FST properties, in particular smoke and heat release. In addition it has low weight coupled with good mechanical properties, surface finish quality, and there is no condensation reaction in contrast to phenolic resins, and a fast cure time that provide the epoxy resin prepreg with numerous advantages over the current phenolic materials that are currently commercially used to produce aircraft interior panels, and panels for other transportation applications, such as in trains. The preferred embodiments of the present invention provide a sandwich panel which exhibits the combination of the key characteristics of a low weight and good mechanical properties, high quality surface finish coupled with high FST properties as a function of the resin content of the prepreg relative to the solid filler content provided by the fire retardant component and in particular the liquid resin content of the prepreg during curing.

The epoxide resin employed in accordance with the preferred embodiments of the present invention is a catalytically-cured non-elimination resin. Therefore no volatiles are released during cure. As compared to condensation-cured resins, such as phenolic resins, this provides the advantage of allowing components to be cured using lower-cost vacuum bag technology with significantly reduced refinishing and processing costs, and does not require autoclave processing.

The epoxide resin employed in accordance with the preferred embodiments of the present invention is a halogen-free, modified-epoxide matrix resin and unlike phenolic systems, does not contain residual phenol or solvents. This means that it can be used in aircraft interior parts such as cosmetic cabin panels and in air-conditioning ducting without the risk of toxic phenol or formaldehyde being leached into the passenger air supply. The halogen-free, epoxide matrix resin avoids the smoke toxicity issues associated with halogenated epoxides.

Fire-retardant fillers were added to the epoxide resin matrix employed in accordance with the preferred embodiments of the present invention to improve the smoke release and smoke toxicity properties of the matrix resin.

The present invention has particular application in the manufacture of multilaminar composite sandwich panels comprising a central core, for example of a honeycomb material itself known in the art, and two opposed outer plies comprising fibre-reinforced composite material incorporating a resin matrix produced in accordance with the present invention.

The preferred embodiments of the present invention provide a prepreg epoxide-containing resin which exhibits a combination of properties in order to achieve sufficient peel adhesion to a core such as a honeycomb core, a high surface quality, for example to provide a cosmetic “A” surface finish, and good FST properties.

First, the epoxide-containing prepreg resin is preferably formulated to have a liquid resin content during cure which is sufficiently high to assure sufficient resin flow during cure in order to form sufficient contact area with the honeycomb cell surface to achieve good adhesion and to have a low void content in the cured resin so that the surface quality of the resultant sandwich panel is high.

Second, the epoxide-containing prepreg resin is formulated to have a liquid resin content during cure which is sufficiently low to reduce the heat and smoke release from the cured resin so that the FST properties of the resultant sandwich panel are high, and in particular comply with the minimum FST properties to qualify for use inside aircraft cabins.

In other words, a preferred liquid resin content during cure provides the combination of (i) high surface quality of the resultant sandwich panel and (ii) high FST properties of the resultant sandwich panel, which comply with the minimum FST properties to qualify for use inside aircraft cabins.

The epoxide-containing matrix resin system used in the prepregs, resultant cured composite materials, and sandwich panels of the present invention has particular application for use for interior panel construction for mass transport applications where a fire, smoke and toxicity requirement is necessary. The composite materials made using such a resin can provide significant advantages over the known resins discussed above, such as phenolic, cyanate-ester, SMC, modified vinyl-ester and halogenated epoxides which have been used in the past for these applications.

The epoxide-containing matrix resin of the preferred embodiments of the present invention may be used in structural applications where fire, smoke and toxicity performance that is similar to phenolic materials is required yet with greatly increased surface quality, and also good mechanical properties such as peel strength of the outer composite material layer to the core of a sandwich panel. Additional advantages include ease of processing and reduced refinishing which allow substantial capital and production cost reductions.

Phenolic resin panels tend to be dark brown in colour and so are commonly painted to achieve the desired component colour. The paint can also improve the surface finish. Problems can occur during service whereby if the material is scratched; the base colour of the phenolic becomes highly visible. The epoxide-containing matrix resin of the preferred embodiments of the present invention may be white or pale grey in colour which reduces the visual impact of such scratching during use, and does not require painting, in particular because the surface finish is high.

The epoxide-containing matrix resin of the preferred embodiments of the present invention can provide a number of technical benefits as compared to known prepregs and composite materials having fire and/or smoke resistance. In particular, there may be provided in accordance with the present invention:
i. A phenol-free alternative to phenolic prepregs.
ii. No volatiles are released during cure—improved mechanical properties.
iii. Does not require high-pressure press tooling or autoclave to process, can use low-cost vacuum-bag technology.
iv. High-quality surface finish “straight from tooling”—does not require expensive and time-consuming refinishing.
v. Pale-colour—requires less surface coating to achieve desired aesthetic and results in increased longevity during operation (i.e. scratches etc. are less visible).

The modified epoxide material produced in accordance with the present invention may be used by manufacturers of composite prepregs and sandwich panels for use in a wide-range of fire-retardant applications. The prepreg offers an alternative to a wide-range of existing fire-retardant materials including (but not limited to) phenolics, halogenated epoxides, and cyanate esters but with significant advantages of the combination of enhanced fire-retardant, smoke and toxicity (FST) properties, enhanced good surface quality, and good mechanical properties, together with good resin processing.

The preferred embodiments of the present invention will now be described further with reference to the following non-limiting Examples.

### Example 1

The mechanical properties of a sandwich panel in accordance with the present invention were calculated. The calculations were based on a sandwich panel comprising:
(i) a front surface layer comprising a fibre-reinforced matrix resin composite material, which is composed of an epoxide resin and a glass/carbon fibre woven fabric;
(ii) a core comprising a honeycomb core material composed of aramid fiber paper coated with a phenolic resin, in particular composed of Nomex® available in commerce from Du Pont, USA. The core had a thickness of 12.7 mm (a ½ inch thickness core);
(iii) a rear surface layer comprising a fibre-reinforced matrix resin composite material, which is composed of an epoxide resin and a glass/carbon fibre woven fabric, and has the same composition as the front surface layer.

The long beam flexural strength and stiffness were calculated based upon the calculation of the deflection of a beam formed from the sandwich panel. In the test setup used for the calculation, a sandwich panel having a width of 24 inches is disposed horizontally and supported on two 1 inch wide load spreader pads mutually spaced 22 inches apart from centre to centre and symmetrically about the centre of the panel. Two further 1 inch wide load spreader pads mutually spaced 4 inches apart from centre to centre and symmetrically about the centre of the panel are located on the upper test face of the sandwich panel. The distance from the centre of each upper load spreader pad to the centre of the respective proximate lower load spreader pad is 9 inches. An applied test pressure is distributed equally between the upper load spreader pads at the centre of the sandwich panel. The downward deflection of the centre of the panel is measured.

The long beam flexural strength was calculated using the following formula:

$${f}_{C} = \frac{P \cdot L}{W \cdot {t}_{c} \cdot ( 2 T + {t}_{t} + {t}_{c} )}$$

where
f_{C}=flexural strength in compression (psi)
P=test load (pounds)
L=distance from centre of each upper load spreader pad to the centre of the respective proximate lower load spreader pad (inches)
W=specimen width (inches)
h=panel thickness (inches)
t_{c}=compression face thickness (inches)
tₜ=tension face thickness (inches)
T=core thickness (inches), and T=h−tₜ−t_{c}

The long beam flexural stiffness is calculated as P/y, where y is the deflection in inches.

Using this test, the desired minimum long beam flexural strength is 25 Ksi, preferably 27 Ksi, and the desired minimum long beam flexural stiffness is 110/lbs/inch.

This test was modelled by calculating the properties of the hybrid glass/carbon interwoven fabrics using a rule of mixtures approach. The modulus in tension and compression of the hybrid glass/carbon fibre interwoven fabric was calculated by a weighted average related to ply thickness e.g. assuming a 50:50 wt % hybrid glass/carbon woven fabric is composed of one carbon fibre fabric and one glass fibre fabric of equal weight, each of which is half the total fabric weight.

The tensile strength of the hybrid glass/carbon fibre interwoven fabric was calculated based on the material which would fail first:

$$σ = E * min ( {ɛ}_{glass} , {ɛ}_{carbon} ) .$$

The compressive strength of the hybrid glass/carbon fibre interwoven fabric was calculated using a ply thickness and material modulus related weighted average failure strain:

$$σ = E * \frac{( {t}_{glass} \cdot {E}_{glass} \cdot {ɛ}_{glass} + {t}_{carbon} \cdot {E}_{carbon} \cdot {ɛ}_{carbon} )}{{t}_{glass} \cdot {E}_{glass} + {t}_{carbon} \cdot {E}_{carbon}} .$$

The total thickness of the hybrid glass/carbon fibre interwoven fabric was calculated as the sum of the thickness of a carbon fibre fabric and glass fibre fabric.

The individual parameters of the carbon fibre fabric and glass fibre fabric were used to calculate the properties of the hybrid glass/carbon fibre interwoven fabric. For example, the parameters for a glass fibre fabric and a carbon fibre fabric are shown in Table 1.

TABLE 1

| | | |
|---|---|---|
| Parameters of individual glass or carbon fabric | E-glass fibre | Carbon fibre |

| | | | |
|---|---|---|---|
| Nominal Cloth fibre weight | g/m² | 300 | 200 |
| Finished ply thickness | Mm | 0.28 | 0.22 |
| E (Tension) | N/mm² | 22800 | 58200 |
| σ (Tension) | N/mm² | 296 | 545 |
| E (Compression) | N/mm² | 24000 | 56100 |
| σ (Compression) | N/mm² | 404 | 566 |
| Poisson's Ratio | — | 0.16 | 0.04 |
| Cured ply weight | g/m² | 544 | 345 |
| Strain to failure (Tensile) | % | 1.30% | 0.94% |
| Strain to failure (Compressive) | % | 1.60% | 0.93% |

The properties for the glass fabric correspond to an 8-harness satin fabric and the properties for the carbon fabric correspond to a twill fabric in which the carbon fibres were in the form of tows each comprising 3k carbon fibre filaments.

Using these parameters, and calculations, and the rule of mixtures as described above, the properties of hybrid glass/carbon interwoven fabrics were calculated (i) for the following total fabric weights: 350, 400, 450, 500, 600 g/m² and also (ii) for the following glass:carbon weight ratios: 0.5:0.5, 0.67:0.33, 0.75:0.25, 0.8:0.2 and 1.0:0.0.

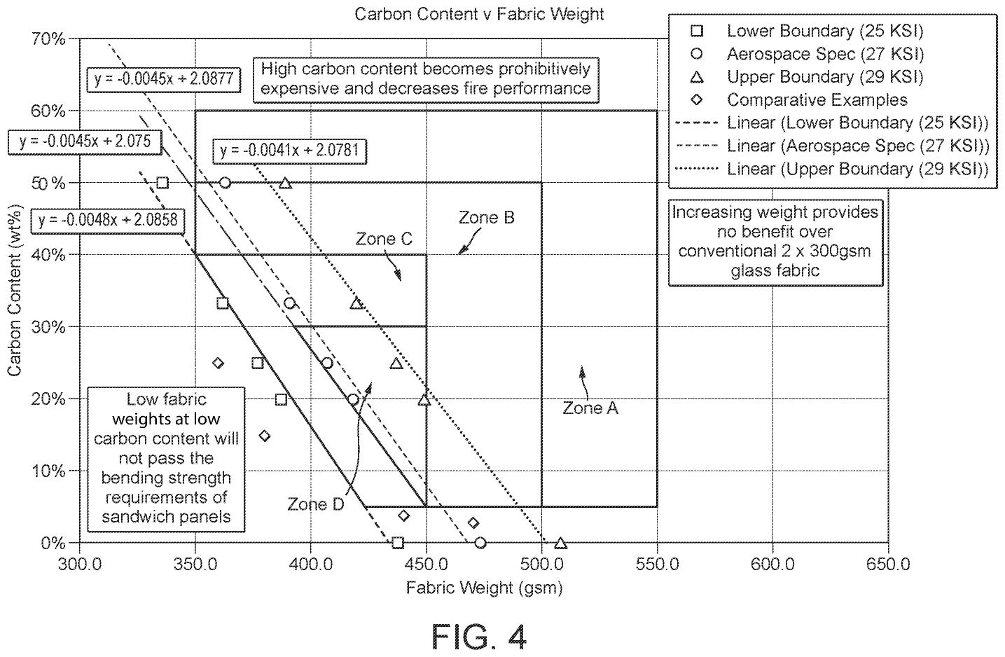

In particular, the long beam flexural strength of the sandwich panel was calculated for various combinations of the total fabric weights and the glass:carbon weight ratios. In calculating the properties of the sandwich panels, each of the front and rear surface layers comprised a single ply of the hybrid glass/carbon fibre interwoven fabric. The results are shown in FIG. 4, which plots calculated values of long beam flexural strength on a graph of carbon fibre content in wt % (y axis) against fabric weight in g/m² (x axis).

As shown in FIG. 4, various combinations of carbon fibre content and fabric weight were found to follow either a first line approximately representing a lower boundary, 25 Ksi, for the long beam flexural strength of the sandwich panel, or a second line approximately representing a typical aerospace specification, 27 Ksi, for the long beam flexural strength of the sandwich panel, or a third line approximately representing an upper boundary, 29 Ksi, for the long beam flexural strength of the sandwich panel. Each of these lines is shown associated with a respective formula, and in each formula the parameter “y” is the carbon fibre content by weight expressed as a fraction relative to the total weight of the hybrid carbon:glass interwoven fabric (although the Y axis identifies that fraction as a wt % value).

As can be seen from FIG. 4, the long beam flexural strength of the sandwich panel along the first line representing the lower boundary of approximately 25 Ksi represents an acceptable minimum long beam flexural strength for aerospace use. The long beam flexural strength of the sandwich panel is approximately at least 25 Ksi when the proportion by weight of carbon fibres, expressed as C in wt %, in the woven fabric ply is defined by the formula (I):

$$C \geq ( - 0.0048 W + 2.0858 ) \times 100 \% \qquad ( I )$$

where W is the weight of the woven fabric ply in g/m²,
   and the proportion by weight of glass fibres, expressed as G wt %, in the woven fabric ply is defined by the formula: G=(100−C) %. The formula (I) defines the first line.

In other words, the inventors have found from numerous experimental results that by providing a fabric according to formula (I), together with the parameters of a particular absolute range for the fabric weight and particular absolute ranges for the carbon and glass fibre proportions in the fabric, the resultant sandwich panel exhibits a minimum desired long beam flexural strength.

As can also be seen from FIG. 4, the long beam flexural strength of the sandwich panel along the second line approximately represents the preferred aerospace specification, 27 Ksi, which represents a preferred long beam flexural strength for aerospace use The long beam flexural strength of the sandwich panel is approximately at least 27 Ksi when the proportion by weight of carbon fibres, expressed as C in wt %, in the woven fabric ply is defined by the formula (II):

$$C \geq ( - 0.0045 W + 2.0877 ) \times 100 \% \qquad ( II )$$

where W is the weight of the woven fabric ply in g/m²,
   and the proportion by weight of glass fibres, expressed as G wt %, in the woven fabric ply is defined by the formula: G=(100−C) %. The formula (II) defines the second line.

In other words, the inventors have found from numerous experimental results that by providing a fabric according to formula (II), together with the parameters of a particular absolute range for the fabric weight and particular absolute ranges for the carbon and glass fibre proportions in the fabric, the resultant sandwich panel exhibits a minimum preferred long beam flexural strength for aerospace applications.

As can still further be seen from FIG. 4, the long beam flexural strength of the sandwich panel along the third line representing the upper boundary of 29 Ksi represents a typical preferred maximum long beam flexural strength for aerospace use since higher long beam flexural strength would generally tend to increase panel weight and/or cost, and/or would generally tend to decrease fire retardancy performance as a result of increased carbon fibre content and increased resin content in absolute amounts. The long beam flexural strength of the sandwich panel is at least 29 Ksi when the proportion by weight of carbon fibres, expressed as C in wt %, in the woven fabric ply is defined by the formula (III):

$$C \geq ( - 0.0041 W + 2.0781 ) \times 100 \% \qquad ( III )$$

where W is the weight of the woven fabric ply in g/m²,
   and the proportion by weight of glass fibres, expressed as G wt %, in the woven fabric ply is defined by the formula: G=(100−C) %. The formula (III) defines the third line.

The lower boundary defines, together with the ranges of the woven fabric ply weight of from 350 to 550 g/m² and from 5 to 60 wt % carbon fibres based on the weight of the woven fabric ply, a Zone A shown in FIG. 4. Zone A defines the composition of the hybrid glass/carbon interwoven fabric ply which provides the technical effect of the combination of sufficient long beam flexural strength in a lightweight panel with acceptable fire retardance and cost to be employed in aerospace applications.

A more preferred sandwich panel comprising the hybrid glass/carbon interwoven fabric ply is defined by Zone B which is defined by the lower boundary together with the ranges of the woven fabric ply weight of from 350 to 500 g/m² and from 5 to 50 wt % carbon fibres based on the weight of the woven fabric ply.

A still more preferred sandwich panel comprising the hybrid glass/carbon interwoven fabric ply is defined by Zone C which is defined by the lower boundary together with the ranges of the woven fabric ply weight of from 350 to 450 g/m² and from 5 to 40 wt % carbon fibres based on the weight of the woven fabric ply.

The most preferred sandwich panel comprising the hybrid glass/carbon interwoven fabric ply is defined by Zone D which is defined by the typical aerospace specification, corresponding to approximately 27 Ksi, in particular slightly below 27 Ksi, for the long beam flexural strength of the sandwich panel together with the ranges of the woven fabric ply weight of from 400 to 450 g/m² and from 5 to 30 wt % carbon fibres based on the weight of the woven fabric ply.

Zone D is represented by a triangle formed by an upper horizontal line defining the maximum carbon fibre content, a right-hand vertical line defining the maximum fabric weight and an inclined line (which is the hypotenuse of the triangle of Zone D) defining the relationship between the carbon fibre content and the fabric weight.

The inclined line defining Zone D is defined by the formula (IV):

$$C \geq ( - 0.0045 W + 2.075 ) \times 100 \% \qquad ( IV )$$

where W is the weight of the woven fabric ply in g/m²,
   and the proportion by weight of carbon fibres in the woven fabric ply is defined as C wt %, and the proportion by weight of glass fibres, expressed as G wt %, in the woven fabric ply is defined by the formula: G=(100−C) %.

The line defining formula (IV) is slightly below the line defining formula (II). In Zone D, the long beam flexural strength of the sandwich panel is approximately at least 27 Ksi, but may be slightly below 27 Ksi, i.e. between the lines defining formula (IV) and formula (II), but this slight difference in long beam flexural strength accommodates experimental error and so would nevertheless provide products meeting accepted aerospace performance criteria for long beam flexural strength.

It can be seen from this formula (IV) that, for example, the combination of a carbon fibre content of 30 wt % and a fabric weight of about 395 g/m², or alternatively a carbon fibre content of 5 wt % and a fabric weight of about 450 g/m², are within Zone D and each provides a long beam flexural strength meeting accepted aerospace performance, which is approximately, or slightly less than, 27 Ksi.

### Example 2

The mechanical properties of a sandwich panel in accordance with the present invention were calculated as described above for Example 1. The calculations were based on a sandwich panel in which the front and rear surface layers comprised 46 wt % of an epoxide resin and 54 wt % of a 400 g/m² glass/carbon fibre woven fabric comprising 50 wt % carbon fibre and 50 wt % glass fibre. The total weight of the front and rear surface layers was 1481 g/m². The properties and results are summarised in Table 2.

The long beam flexural strength of the sandwich panel was calculated as 29.83 Ksi, i.e. kilopounds per square inch, (equivalent to 20.57 kilonewton/centimeter²). This long beam flexural strength is above a minimum standard of 27 Ksi (equivalent to 18.62 kilonewton/centimeter²) that is set by a well-known aircraft manufacturer.

The long beam flexural stiffness of the sandwich panel was calculated as 184.91 lbs/in, i.e. pounds per inch (equivalent to 32383 N/m). This long beam flexural stiffness is above a minimum standard of 110 lbs/in (equivalent to 19264 N/m) that is set by a well-known aircraft manufacturer.

TABLE 2

| | | Long Beam Flexural | Long Beam Flexural |
|---|---|---|---|
| | Interwoven Fabric | Strength - Ksi | Stiffness - lbs/in |
| | Composition - wt % | (kN/cm²) | (N/m) |
| Example 2 | 50 carbon:50 glass | 29.83 (20.57) | 184.91 (32383) |
| Example 3 | 33.3 carbon:66.6 glass | 27.42 (18.91) | 154.28 (27019) |
| Example 4 | 25 carbon:75 glass | 26.17 (18.04) | 139.01 (24344) |
| Example 5 | 20 carbon:80 glass | 25.41 (17.52) | 129.86 (22742) |

Accordingly, the sandwich panel exhibited high long beam flexural strength and long beam flexural stiffness, exceeding a minimum threshold of a commercial aircraft manufacturer for interior panels, despite having a low total weight of the sandwich panel. The panel would also exhibit a high quality surface finish using the interwoven fabric as described above, and good FST properties, as a result of incorporating the FST fillers as described above, meeting the minimum criteria for aircraft interior panels.

### Example 3

The mechanical properties of another sandwich panel in accordance with the present invention were calculated. This panel differed from the panel of Example 2 by modifying the weight ratio of the carbon fibres and the glass fibres in the woven fabric as shown in Table 2 to provide a lower proportion of carbon fibres in Example 3 than in Example 2.

The long beam flexural strength and long beam flexural stiffness of the sandwich panel were again calculated as shown in Table 2. The long beam flexural strength was above a minimum standard of 27 Ksi (equivalent to 18.62 kilonewton/centimeter²) and the long beam flexural stiffness was above a minimum standard of 110 lbs/in (equivalent to 19264 N/m), each set by a well-known aircraft manufacturer.

Accordingly, the sandwich panel exhibited high long beam flexural strength and long beam flexural stiffness, exceeding a minimum threshold of a commercial aircraft manufacturer for interior panels, despite having a low total weight of the sandwich panel. As for Example 2, the panel would also exhibit a high quality surface finish, and good FST properties meeting the minimum criteria for aircraft interior panels.

### Example 4

The mechanical properties of another sandwich panel in accordance with the present invention were calculated. This panel differed from the panel of Example 3 by modifying the weight ratio of the carbon fibres and the glass fibres in the woven fabric as shown in Table 2 to provide a lower proportion of carbon fibres in Example 4 than in Example 3.

The long beam flexural strength and long beam flexural stiffness of the sandwich panel were again calculated as shown in Table 2. The long beam flexural strength of the sandwich panel was calculated as 26.17 Ksi, i.e. kilopounds per square inch, (equivalent to 18.04 kilonewton/centimeter²). This long beam flexural strength is below a preferred standard of 27 Ksi (equivalent to 18.62 kilonewton/centimeter²) that is set by a well-known aircraft manufacturer, but nevertheless acceptable for some applications by being above 25 Ksi. The long beam flexural stiffness of the sandwich panel was calculated as 139.01 lbs/in, i.e. pounds per inch (equivalent to 24344 N/m). This long beam flexural stiffness is above a minimum standard of 110 lbs/in (equivalent to 19264 N/m) that is set by a well-known aircraft manufacturer.

Accordingly, the sandwich panel exhibited high long beam flexural stiffness, and acceptable long beam flexural strength, and so would meet the minimum threshold for aircraft interior panels.

### Example 5

In this Example, this panel differed from the panel of Example 4 by modifying the weight ratio of the carbon fibres and the glass fibres in the woven fabric to comprise 80 wt % glass fibres and 20 wt % carbon fibres (i.e. the proportion of carbon fibres was lower in Example 5 than in Examples 2 to 4) as shown in Table 2.

The mechanical properties of the sandwich panel were calculated and shown in Table 2. The long beam flexural strength of the sandwich panel was calculated as 25.41 Ksi, i.e. kilopounds per square inch, (equivalent to 17.52 kilonewton/centimeter²). This long beam flexural strength is below a preferred standard of 27 Ksi (equivalent to 18.62 kilonewton/centimeter²) that is set by a well-known aircraft manufacturer, but nevertheless acceptable for some applications by being above 25 Ksi. The long beam flexural stiffness of the sandwich panel was calculated as 129.86 lbs/in, i.e. pounds per inch (equivalent to 22742 N/m). This long beam flexural stiffness is above a minimum standard of 110 lbs/in (equivalent to 19264 N/m) that is set by a well-known aircraft manufacturer.

Accordingly, the sandwich panel exhibited high long beam flexural stiffness, and acceptable long beam flexural strength, and so would meet the minimum threshold for aircraft interior panels.

### Comparative Example 1

In this Comparative Example, this panel differed from the panel of Example 2 by using a 500 g/m² woven glass fibre fabric instead of the 400 g/m² woven fabric comprising both carbon fibres and glass fibres. In this comparative example, the woven fabric comprised only glass fibres and was 100 g/m² heavier than the woven fabrics used in Examples 2 to 5. Thus, the total weight of the front and rear surface layers was 1851 g/m².

The mechanical properties of the sandwich panel were calculated. The long beam flexural strength of the sandwich panel was calculated as 28.6 Ksi, above the minimum standard of 27 Ksi (equivalent to 18.62 kilonewton/centimeter²) that is set by a well-known aircraft manufacturer and the long beam flexural stiffness of the sandwich panel was calculated as 110 lbs/in, just meeting the minimum standard of 110 lbs/in (equivalent to 19264 N/m) that is set by a well-known aircraft manufacturer.

Accordingly, the sandwich panel exhibited acceptable long beam flexural strength and long beam flexural stiffness, but excessive areal weight for use as aircraft interior panels.

It is pointed out that the use of an epoxy resin matrix combined with a 500 g/m² woven glass fibre fabric can provide the required mechanical performance which is nevertheless unexpected given that a phenolic resin matrix combined with a 500 g/m² woven glass fibre fabric would not provide the required mechanical performance as a phenolic resin sandwich panel with 500 g/m² woven glass fibre fabric in each outer layer would fail at a long beam flexural strength lower than 27 Ksi. In contrast, conventional phenolic resin sandwich panels incorporate 600 g/m² woven glass fibre fabric in each outer layer (as two plies of 300 g/m² woven glass fibre fabric) in order to provide the required long beam flexural strength of 27 Ksi. In each case, using woven glass fibre fabric in an epoxy or phenolic resin matrix requires a sandwich panel of excessive weight, as compared to the present invention, in order to achieve the required long beam flexural strength of 27 Ksi

Similar panels to Comparative Example 1 comprising glass fibre woven fabric plies having lower fabric weights of 400 g/m² and 300 g/m² were tested by calculation. These panels exhibited worse mechanical properties than the panel of Comparative Example 1, and both the long beam flexural strength and the long beam flexural stiffness were lower than the required respective values, and so would not meet the minimum threshold of a commercial aircraft manufacturer for interior panels.

### Comparative Example 2

In this Comparative Example, this panel differed from the panel of Example 2 by using, to make each of the front and rear surface layers, a stack of two prepregs, each prepreg comprising respective woven fabric comprising only glass fibres and no carbon fibres, instead of a single prepreg comprising a woven fabric comprising both glass fibres and carbon fibres as used in Example 1. In each prepreg used in this Comparative Example, the woven fabric, known in the art as a “7781 fibreglass fabric”, was an 8-harness satin weave which comprised 100 wt % glass fibres and had a fabric weight of 300 g/m².

Therefore the sandwich panel in accordance with Comparative Example 2 comprised:
(i) a front surface layer comprising a fibre-reinforced matrix resin composite material, which was formed from a stack of two prepregs, each composed of 46 wt % of an epoxide resin and 54 wt % of a 300 g/m² glass fibre woven fabric;
(ii) a core comprising a honeycomb core material composed of aramid fiber paper coated with a phenolic resin, in particular composed of Nomex® available in commerce from Du Pont, USA. The core had a thickness of ½ inch;
(iii) a rear surface layer comprising a fibre-reinforced matrix resin composite material, which was formed from a stack of two prepregs, each composed of 46 wt % of an epoxide resin and 54 wt % of a 300 g/m² glass fibre woven fabric.

The sandwich panel therefore comprised a total of 4 plies of 300 g/m² woven glass fibre fabric as compared to a total of 2 plies of 400 g/m² woven glass/carbon fibre fabric used in Example 2.

The total weight of the front and rear surface layers was 2222 g/m². This is significantly higher, i.e. 741 g/m² higher, than the total weight of the front and rear surface layers in Examples 2 to 5.

The mechanical properties of the sandwich panel were calculated. The long beam flexural strength of the sandwich panel was calculated as 33.3 Ksi, i.e. kilopounds per square inch, (equivalent to 22.96 kilonewton/centimeter²). The long beam flexural stiffness of the sandwich panel was calculated as 120 lbs/in, i.e. pounds per inch (equivalent to 21015 N/m).

Accordingly, although the 2×glass fibre plies/core/2×glass fibre plies sandwich panel exhibited acceptable long beam flexural stiffness and long beam flexural strength, nevertheless the weight of the panel was significantly higher than for the Examples of the sandwich panels produced in accordance with the present invention.

### Comparative Examples 3 to 6

In these Comparative Examples interwoven carbon:glass fabrics were used in the outer surface layers but the interwoven carbon:glass fabrics had a combination of fabric weight and weight ratio of carbon:glass outside the scope of the present invention. The properties and performance are summarised in Table 3 and shown in FIG. 4.

TABLE 3

| | Interwoven Fabric | Long Beam Flexural | Long Beam Flexural |
|---|---|---|---|
| | Composition - wt %, | Strength - Ksi | Stiffness - lbs/in |
| | g/m² | (kN/cm²) | (N/m) |
| Comparative | 25 carbon:75 glass | 23.9 (16.48) | 114 (19965) |
| Example 3 | 360 gsm | | |
| Comparative | 15 carbon:85 glass | 23.9 (16.48) | 106 (18563) |
| Example 4 | 380 gsm | | |
| Comparative | 4 carbon:96 glass | Not measured | 103 (18038) |
| Example 5 | 440 gsm | | |
| Comparative | 3 carbon:97 glass | Not measured | 109 (19088) |
| Example 6 | 470 gsm | | |

From Comparative Examples 3 and 4 it can be seen that at relatively low fabric weights, even adding significant carbon fibre content fails to achieve the required long beam flexural strength.

From Comparative Examples 5 and 6 it can be seen that even at relatively high fabric weights, adding low carbon fibre content fails to achieve the required long beam flexural stiffness, i.e. long beam flexural modulus.

Thus Examples 1 to 5 and Comparative Examples 3 to 6 cumulatively show that by providing a specific hybrid interwoven carbon; glass fibre fabric, having a specific relationship between the fabric weight and the carbon:glass fibre weight ratio, in a prepreg, and in a resultant sandwich panel incorporating such fabric, in which the resin matrix is an epoxy resin filled with FST solid fillers, the combination of low areal weight and high mechanical properties for aerospace applications can be achieved.

The data of Examples 1 to 5 and Comparative Examples 1 to 6 cumulatively show that by providing a specific prepreg configuration a sandwich panel can be made that exhibits low areal weight yet provides high mechanical properties in combination with good surface finish and FST properties. In particular, by providing a prepreg comprising an epoxide resin matrix system and a specific fibrous reinforcement, which is a woven fabric ply comprising an interwoven mixture of glass fibres and carbon fibres, wherein the woven fabric ply has a weight of from 350 to 550 g/m² and comprises from 40 to 95 wt % glass fibres and from 5 to 60 wt % carbon fibres, each based on the weight of the woven fabric ply, and the wherein the proportion by weight of carbon fibres, expressed as C wt %, in the woven fabric ply is defined by the formula: C≥(−0.0048W+2.0858)×100%, where W is the weight of the woven fabric ply in g/m², and the proportion by weight of glass fibres, expressed as G wt %, in the woven fabric ply is defined by the formula: G=(100−C) %, the prepreg can have low weight and high strength.

A single ply of the glass/carbon hybrid fabric on each side of the sandwich panel can provide a significant weight decrease without compromising mechanical properties, surface finish or FST properties, all of which are required in sandwich panels for vehicle interiors, particularly aircraft interior panels.

Such a prepreg can comprise a typical resin content of from 35 to 50 wt % of the epoxide resin matrix system and from 50 to 65 wt % fibrous reinforcement, each wt % being based on the total weight of the prepreg, and the epoxide resin matrix system can readily incorporate solid fillers for providing fire retardant properties to the fibre-reinforced composite material.

As the data of Examples 1 to 5 and Comparative Examples 1 to 6 shows, reducing the proportion of carbon fibres in the woven fabric ply data to below 5 wt % can excessively reduce the long beam flexural modulus of the panel when only one woven fabric ply is used on each surface of the sandwich panel.

Although the long beam flexural modulus is not shown in FIG. 4, the reason that the minimum carbon fibre content is shown as 5 wt % in FIG. 4 (i.e. Zones A to D all have a minimum carbon fibre content of 5 wt %) is that at lower carbon fibre content of below 5 wt % the long beam flexural modulus, or long beam flexural stiffness, of the sandwich panel is too low for aerospace applications within the limits of acceptable ply weight.

If the proportion of carbon fibres in the woven fabric ply data is greater than to 60 wt %, this can provide an excessive amount of combustible carbon in the panel, which would increase the heat release on combustion above an acceptable maximum threshold, and in addition the cost of the sandwich panel increases significantly.

The filler content can provide a good surface finish as well as FST properties.

The woven fabric ply comprising an interwoven mixture of glass fibres and carbon fibres can select a weave to provide improved surface properties, and improved drape of the woven fabric during layup of the prepreg on the core to form the sandwich panel.

The epoxide resin is formulated to provide a high liquid content in the prepreg upon curing, preferably at least 140 g/m² for each surface layer. This can ensure a high strength bonding to the core, which would exhibit a high climbing drum peel strength for example, and can provide that a high content of solid fillers can be carried in the epoxide resin. Accordingly, the panel can exhibit high FST properties without compromising panel strength or surface finish. A high liquid content in the epoxide resin prepreg upon curing can also provide a low void content in the surface layers of the sandwich panel. However, providing an excessively high liquid content in the prepreg upon curing of above about 205 g/m² can result in high smoke density and high peak heat release during combustion, which are undesirable. It is believed that an increased liquid resin content provides a higher organic material content for combustion.

In summary, Examples 1 to 5 and Comparative Examples 1 to 6 cumulatively show that by providing a specific single ply fibrous reinforcement in a single prepreg on each side of a sandwich panel, preferably in combination with selected ranges for the amount of solid fillers and for the liquid content in the epoxy resin prepreg upon curing, the desired combination of both a good surface finish and high FST properties can be achieved in a low weigh/high strength sandwich panel having epoxy resin composite material outer surface layers.

Various modifications to the preferred embodiments of the present invention, as defined in the appended claims, will be apparent to those skilled in the art.

1. A prepreg for the manufacture of a fibre-reinforced composite material having fire retardant properties, the prepreg comprising an epoxide resin matrix system and fibrous reinforcement, the fibrous reinforcement being at least partially impregnated by the epoxide resin matrix system,
wherein the epoxide resin matrix system comprises the components:
a. a mixture of (i) at least one epoxide-containing resin and (ii) at least one catalyst for curing the at least one epoxide-containing resin; and
b. a plurality of solid fillers for providing fire retardant properties to the fibre-reinforced composite material formed after catalytic curing of the at least one epoxide-containing resin, the plurality of solid fillers having different respective chemical compositions, and
wherein the fibrous reinforcement comprises a woven fabric ply comprising an interwoven mixture of glass fibres and carbon fibres, wherein the woven fabric ply has a weight of from 350 to 550 g/m² and comprises from 40 to 95 wt % glass fibres and from 5 to 60 wt % carbon fibres, each based on the weight of the woven fabric ply, and wherein the proportion by weight of carbon fibres, expressed as C in wt %, in the woven fabric ply is defined by the formula:
$$C \geq ( - 0.0048 W + 2.0858 ) \times 100 \% ,$$
where W is the weight of the woven fabric ply in g/m²,
and the proportion by weight of glass fibres, expressed as G wt %, in the woven fabric ply is defined by the formula: G=(100−C) %.

2. A prepreg according to claim 1 wherein the woven fabric ply has a weight of from 350 to 500 g/m² and comprises from 50 to 95 wt % glass fibres and from 5 to 50 wt % carbon fibres, each based on the weight of the woven fabric ply.

3. A prepreg according to claim 2 wherein the woven fabric ply has a weight of from 350 to 450 g/m² and comprises from 60 to 95 wt % glass fibres and from 5 to 40 wt % carbon fibres, each based on the weight of the woven fabric ply.

4. A prepreg according to claim 3 wherein the woven fabric ply has a weight of from 400 to 450 g/m² and comprises from 70 to 95 wt % glass fibres and from 5 to 30 wt % carbon fibres, each based on the weight of the woven fabric ply.

5. A prepreg according to claim 1 wherein the proportion by weight of carbon fibres, expressed as C in wt %, in the woven fabric ply is defined by the formula:
$$C \geq ( - 0.0045 W + 2.075 ) \times 100 \% ,$$
where W is the weight of the woven fabric ply in g/m²,
and the proportion by weight of glass fibres, expressed as G wt %, in the woven fabric ply is defined by the formula: G=(100−C) %.

6. A prepreg according to claim 1 wherein the woven fabric ply comprises an interwoven mixture of glass fibre tows and carbon fibre tows, each tow comprising a plurality of filaments of glass fibre or carbon fibre respectively, and each interwoven carbon fibre tow comprises from 2000 to 7000 carbon fibre filaments, from 3000 to 6000 carbon fibre filaments, or about 3000 carbon fibre filaments.

7. A prepreg according to claim 1 wherein the woven fabric ply comprises a satin weave which is an n-harness satin weave in which n is an integer of at least 4, or from 5 to 8, or 5.

8. A prepreg according to claim 1 wherein the prepreg comprises from 35 to 50 wt % of the epoxide resin matrix system and from 50 to 65 wt % fibrous reinforcement, each wt % being based on the total weight of the prepreg.

9. A prepreg according to claim 8 wherein the prepreg comprises from 35 to 45 wt % of the epoxide resin matrix system and from 55 to 65 wt % fibrous reinforcement, each wt % being based on the total weight of the prepreg.

10. A prepreg according to claim 9 wherein the prepreg comprises from 38 to 42 wt % of the epoxide resin matrix system and from 58 to 62 wt % fibrous reinforcement, each wt % being based on the total weight of the prepreg.

11. A prepreg according to claim 1 wherein in the epoxide resin matrix system the weight ratio of component a. to component b is from 1.4:1 to 1.86:1, or from 1.5:1 to 1.86:1, or from 1.6:1 to 1.7:1.

12. A prepreg according to claim 1 wherein the weight ratio of the total weight of the prepreg to the weight of component b is from 4.5:1 to 6.5:1, or from 5:1 to 6:1.

13. A prepreg according to claim 1 wherein the epoxide resin matrix system comprises a liquid-forming component of the prepreg, which liquid-forming component is adapted to liquefy at a curing temperature during curing of the at least one epoxide-containing resin by the at least one catalyst, wherein the liquid-forming component of the prepreg has a weight of from 140 to 205 g/m².

14. A prepreg according to claim 1 wherein the prepreg has a total weight of from 550 to 800 g/m² or from 550 to 700 g/m².

15. A prepreg according to claim 1 wherein the solid fillers for providing fire retardant properties comprise component (i) a phosphate component and component (ii) (a) a ceramic or glass material precursor for reacting with the phosphate component to form a ceramic or glass material and/or (b) a ceramic or glass material and/or (c) an intumescent material comprising intercalated graphite, and optionally component (iii) a blowing agent for generating a non-combustible gas, whereby the fire retardant solid fillers and blowing agent form an intumescent char, when the prepreg, or fibre-reinforced composite material made therefrom, is exposed to a fire.

16. A prepreg according to claim 15 wherein in component (i) the phosphate component comprises a metal or ammonium monophosphate or polyphosphate, and/or in component (i) the ceramic or glass material precursor comprises a metal borate or metal silicate, and/or the ceramic or glass material comprises glass beads and/or the intumescent material comprises intercalated graphite, and/or in component (iii) the blowing agent comprises melamine.

17. A prepreg according to claim 1 wherein the epoxide resin matrix system further comprises, in component b, at least one anti-settling agent for the solid fillers, wherein the settling agent is a solid particulate material.

18. A prepreg according to claim 1 wherein the prepreg is halogen-free and/or phenolic resin-free.

19. A fire-retardant sandwich panel for use as an interior component in a vehicle, optionally an interior panel of an aircraft or a railway vehicle, the sandwich panel comprising a core layer and an outer surface layer bonded to a surface of the core layer, wherein the outer surface layer comprises a fibre-reinforced composite material formed from at least one layer of a prepreg according to claim 1.

20. A fire-retardant sandwich panel for use as an interior component in a vehicle, optionally an interior panel of an aircraft or a railway vehicle, the sandwich panel comprising a core layer and an outer surface layer bonded to a surface of the core layer, wherein the outer surface layer comprises a fibre-reinforced composite material comprising a cured epoxide resin matrix and fibrous reinforcement,
wherein the cured epoxide resin matrix comprises the components:
a. a cured epoxide resin; and
b. a plurality of solid fillers dispersed throughout the cured epoxide resin for providing fire retardant properties to the fibre-reinforced composite material,
wherein the fibrous reinforcement comprises a woven fabric ply comprising an interwoven mixture of glass fibres and carbon fibres, wherein the woven fabric ply has a weight of from 350 to 550 g/m² and comprises from 40 to 95 wt % glass fibres and from 5 to 60 wt % carbon fibres, each based on the weight of the woven fabric ply, and wherein the proportion by weight of carbon fibres, expressed as C in wt %, in the woven fabric ply is defined by the formula:
$$C \geq ( - 0.0048 W + 2.0858 ) \times 100 \% ,$$
where W is the weight of the woven fabric ply in g/m²,
and the proportion by weight of glass fibres, expressed as G wt %, in the woven fabric ply is defined by the formula: G=(100−C) %.

21-33. (canceled)

34. A method of making a fire-retardant sandwich panel according to claim 20, the method comprising the steps of:
i. providing a core layer;
ii. disposing a prepreg according to claim 1 onto a surface of the core layer to form a sandwich panel pre-assembly;
iii. heating the sandwich panel pre-assembly to a curing temperature of the at least one epoxide-containing resin by the at least one catalyst, wherein in step iii the at least one epoxide-containing resin, and optionally the at least one catalyst, liquefy and wet the surface of the core layer.

35. A method according to claim 34 further comprising, during the heating step, pressing together the prepreg and core layer while curing the at least one epoxide-containing resin to form the layer of fibre-reinforced composite material bonded to the core layer.

36. A method according to claim 35 wherein the prepreg and core layer are pressed together for a period of from 5 to 20 minutes at a temperature of from 125 to 185° C.

37. A method according to claim 34, wherein during curing surface of the core layer is wet by a liquid-forming component of the at least one epoxide-containing resin, and optionally the catalyst therefor, which liquid-forming component has a weight of from 140 to 205 g/m², from 150 to 180 g/m² or from 155 to 170 g/m²
